(19) United States
(12) Patent Application Publication
(10) Pub. No.: US 2005/0073437 A1
(43) Pub. Date: Apr. 7, 2005

(54) Pedestrian presence indicator

(76) Inventor: Michael Perri, Montreal-Nord (CA)

Correspondence Address: Michael Perri, 6016, Crevier, Montreal-Nord, QC, H1G 2E1, CA

(21) Appl. No.: 10/666,055

(22) Filed: Sep. 22, 2003

(51) Int. Cl. G08G 1/095

(52) U.S. Cl. 340/944; 340/470

(57) ABSTRACT

A pedestrian presence indicator mountable to a vehicle for warning nearby traffic about the presence of a pedestrian within a target zone positioned in front or in back of the vehicle within a predetermined distance from the vehicle. The indicator includes a sensing device mounted to the vehicle for sensing the presence of the pedestrian upon the pedestrian being positioned within the target zone and a signaling device coupled to the sensing device for emitting a warning signal perceivable by the nearby traffic upon the sensing device sensing the presence of the pedestrian within the target zone. The signaling device includes four lasers respectively mounted to the vehicle adjacent a corresponding corner section thereof. Each of the lasers is typically a non-Gaussian laser allowing for the emission of a red colored laser beam over a distance of approximately four feet and directed substantially perpendicularly relative to the vehicle longitudinal axis.

### FIELD OF THE INVENTION

The present invention relates to the general field of traffic safety devices and is particularly concerned with a pedestrian presence indicator.

### BACKGROUND OF THE INVENTION

It is known that pedestrians, bicycle riders, in-line skaters and the like are especially endangered and exposed to a considerable chance of injury in the event of a collision with a motor vehicle because of the absence of suitable protection. These injuries are due in particular to the fact that in a collision between a vehicle and a human body, part of the human body will directly strike the hard and relatively unyielding body parts of the vehicle traveling at relatively high speeds.

There have been many and are many items of equipment and apparel intended for use by persons undertaking activities in areas that they must share with motorized vehicles, so that these persons will be seen by motorists and not accidentally injured or killed. Today, many of these persons wear bright, colored or reflective clothing in order to be visible to oncoming motorists.

Furthermore, there have been and are garments equipped with means of illumination and lights that are portable or securable to an article of clothing.

Although somewhat useful, these pedestrians' signaling devices suffer from major drawbacks. First, they are only worn by a small percentage of individuals that plan a given activity nearby traffic. Second, they only provide visual clues to potential drivers when worn by individuals that are in the line of sight or in the general visual field of the driver. Hence, there exists many situations wherein even individuals wearing a specifically designed signaling piece of apparel will remain invisible to the drivers of nearby traffic until they reach a position wherein avoidance of a collision between the vehicle and a human body becomes difficult if not impossible because of the inertia and speed of the vehicle.

One relatively common example of a situation wherein pedestrians may become visible too late to avoid collision with a vehicle is all too common situation wherein pedestrians or the like step out into the roadway from a position between parked vehicles that have previously provided a visual shield. This type of situation is unfortunately relatively common when, e.g., children playing, chasing a ball or the like, run out from between vehicles into the traffic. The children being relatively small are hidden from the visual field of the driver until the very last second, sometimes leading to situations wherein collision becomes unavoidable. The problem is, of course, compounded in situations wherein visibility of the motorist is impaired by darkness and/or inclement weather conditions such as, fog, rain, snow or the like.

At present, even austere vehicles are provided with signaling and lighting systems including, high and low beams, parking back-up and flashing lights. Some automobiles also come equipped with search lights, fog lights and the like.

However, presently, vehicles not include any type of warning system for providing a warning to the effect that a pedestrian positioned within a predetermined detecting range of a vehicle is shielded by latter and may potentially become a target for collision on the adjacent roadway. Accordingly, there exists a need for a pedestrian presence indicator.

### SUMMARY OF THE INVENTION

In accordance with the present invention, there is provided a pedestrian presence indicator mountable to a vehicle for warning nearby traffic about the presence of a pedestrian within a predetermined target zone; the vehicle defining a vehicle front end, a vehicle rear end, a pair of vehicle side ends and a vehicle longitudinal axis, the vehicle also including a vehicle electric circuitry powered by a vehicle battery, the vehicle circuitry including an ignition switch; the sign signaling device comprising: a sensing means mounted to the vehicle for sensing the presence of the pedestrian upon the pedestrian being positioned within the target zone; a signaling means coupled to the sensing means for emitting a warning signal perceivable by the nearby traffic upon the sensing means sensing the presence of the pedestrian within the target zone.

Conveniently, the signaling means emits the warning signal when the pedestrian is positioned in front or in back of the vehicle within a predetermined distance from the vehicle. Typically, the predetermined distance is approximately three feet.

Conveniently, the signaling means is not activated by the presence of the pedestrian along side the vehicle. Typically, the sensing means includes a motion detector. Conveniently, the motion detector is a microwave sensor.

Typically, the microwave sensor is configured, sized and positioned so that the microwave sensor does not sense the presence of the pedestrian when the pedestrian is located along side the vehicle.

Conveniently, the sensing means includes a front microwave sensor and a rear microwave sensor, the front and rear microwave sensors being respectively positioned underneath the hood and inside the trunk of the vehicle; the front and rear microwave sensors being configured, sized and positioned so as to use the metallic components of the vehicle as microwave shields for ensuring that the microwave sensors do not sense the presence of the pedestrian when the pedestrian is located along side the vehicle.

Typically, the microwave sensor is protectively enclosed within a polymeric sensor shield, the sensor shield being secured to the vehicle. Conveniently, the signaling means allows for the emission of a visual warning signal. Typically, the signaling means allows for the emission of a visual warning signal positioned so as to be visible by nearby traffic when the vehicle is parked in parallel alongside a road.

Conveniently, the signaling means includes a laser mounted to the vehicle. Typically, the laser is a non-Gaussian laser. Conveniently, the laser allows for the emission of a red colored laser beam. Typically, the laser is mounted to the vehicle so as to emit a laser beam substantially perpendicular to the vehicle longitudinal axis.

Conveniently, the laser is a non-Gaussian laser allowing for the emission of a red colored laser beam over a distance of approximately four feet and directed substantially perpendicularly relative to the vehicle longitudinal axis.

Typically, the signaling means includes four lasers respectively mounted to the vehicle adjacent a corresponding corner section thereof. Conveniently, each of the lasers is a non-Gaussian laser allowing for the emission of a red colored laser beam over a distance of approximately four feet and directed substantially perpendicularly relative to the vehicle longitudinal axis.

Conveniently, the signaling means includes a strobe light mounted to the vehicle. Typically, the signaling means includes four strobe lights respectively mounted to the vehicle adjacent a corresponding corner section thereof.

Conveniently, the indicator further comprises an activating means for selectively activating the sensing means and the signaling means upon the ignition switch being set in an off position.

Typically, the indicator further comprises a delay means for delaying the activation of the sensing and signaling means for a predetermined delay period upon the ignition switch being set in an off position.

Conveniently, the indicator further comprises a signal maintaining means for maintaining the emission of the warning signal for a predetermined duration period upon the signaling means being activated.

Typically, the indicator further comprises a remote control for allowing selective remote activation and deactivation of the sensing and signaling means.

In accordance with the present invention, there is also provided, in combination, a vehicle and a pedestrian presence indicator mounted on the vehicle for warning nearby traffic about the presence of a pedestrian within a predetermined target zone; the vehicle defining a vehicle front end, a vehicle rear end, a pair of vehicle side ends and a vehicle longitudinal axis, the vehicle also including a vehicle electric circuitry powered by a vehicle battery, the vehicle circuitry including an ignition switch; the sign signaling device comprising: a sensing means mounted to the vehicle for sensing the presence of the pedestrian upon the pedestrian being positioned within the target zone; a signaling means coupled to the sensing means for emitting a warning signal perceivable by the nearby traffic upon the sensing means sensing the presence of the pedestrian within the target zone.

Typically, the signaling means emits the warning signal when the pedestrian is positioned in front or in back of the vehicle within a predetermined distance from the vehicle.

Conveniently, the sensing means includes a front microwave sensor and a rear microwave sensor, the front and rear microwave sensors being respectively positioned underneath the hood and inside the trunk of the vehicle; the front and rear microwave sensors being configured, sized and positioned so as to use the metallic components of the vehicle as microwave shields for ensuring that the microwave sensors do not sense the presence of the pedestrian when the pedestrian is located along side the vehicle.

Typically, the signaling means allows for the emission of a visual warning signal positioned so as to be visible by nearby traffic when the vehicle is parked in parallel alongside a road.

Conveniently, the signaling means includes a laser mounted to the vehicle. Typically, the laser is mounted to the vehicle so as to emit a laser beam substantially perpendicular to the vehicle longitudinal axis.

Conveniently, the laser is a non-Gaussian laser allowing for the emission of a red colored laser beam over a distance of approximately four feet and directed substantially perpendicularly relative to the vehicle longitudinal axis.

Advantages of the present invention include that the proposed vehicle safety device allows the detection of the presence of pedestrians or individuals within a predetermined range of a parked vehicle and the emission of a signal to the adjacent traffic to the effect that the detected individual may present a collision hazard. The proposed device is thus adapted to send out a warning signal allowing the nearby traffic to be aware of the presence of a pedestrian even if the latter is visually hidden by the parked cars. Hopefully, the nearby traffic is thus given a warning signal within a range allowing for adjustment of the speed to a speed procuring a safe stopping distance.

The warning signal sent by the proposed device is such that it can be perceived by nearby traffic within a predetermined range even in difficult conditions and in bright day light.

The device provides for adjustment of the detection range so that the latter may be adjusted to the area typically in front and in back of a vehicle parked in parallel adjacent to other vehicles.

The device is adapted to be turned on whenever the vehicle is not running and is provided with an activation component allowing the device to be turned off in situations wherein the device would be unduly turned on as, e.g., in situations wherein the car is parked in a relatively large parking lot. Optionally, the device may be provided with a remote system allowing remote activation and deactivation of the device.

Furthermore, the proposed device is specifically designed so as to be either built-in to new vehicles or retrofitted into existing vehicles. The device is specifically designed so as to be manufacturable using conventional components through conventional methods of manufacturing so as to provide a device that will be economically feasible, long lasting and relatively trouble free in operation.

### BRIEF DESCRIPTION OF THE DRAWINGS

An embodiment of the present invention will now be disclosed, by way of example, in reference to the following drawings, in which:

FIG. 1: in a schematic top view, illustrates a vehicle safety device in accordance with an embodiment of the present invention, mounted on a conventional vehicle. The conventional vehicle being part in parallel relationship relative to other cars along the curb of a given roadway;

FIG. 2: in a schematic diagram, illustrates part of the electronic circuitry associated with the vehicle safety device in accordance with the present invention.

### DETAILED DESCRIPTION

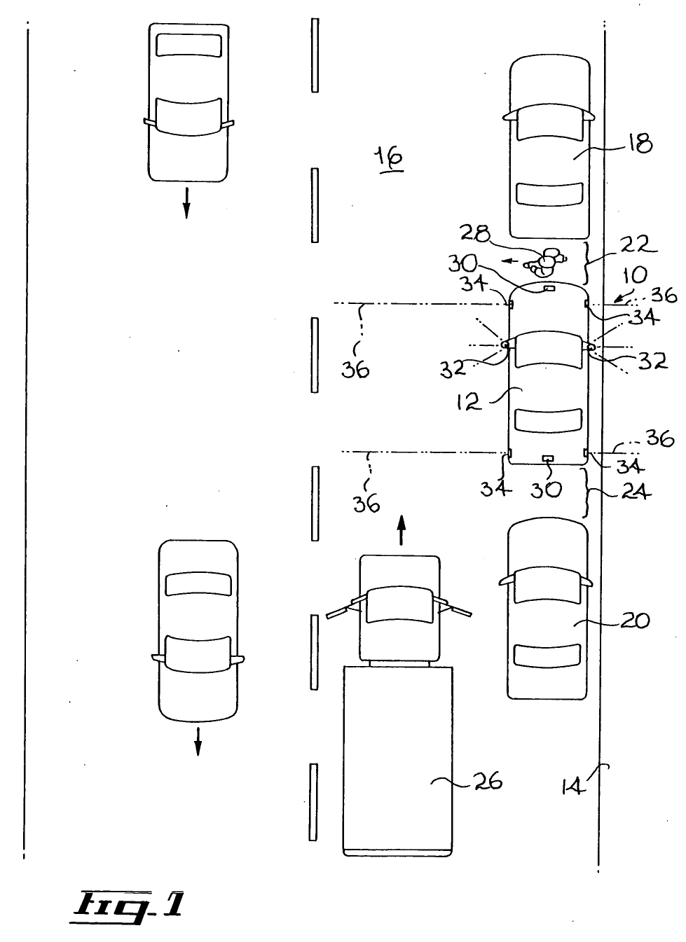

Referring to FIG. 1, there is shown a vehicle safety device (10) mounted on a conventional vehicle (12) parked alongside the curb (14) of a conventional roadway (16). The vehicle (12) equipped with the safety device (10) is shown parked in parallel between a frontwardly located vehicle (18) and a rearwardly located vehicle (20).

Front and rear spacings (22), (24) are respectively defined between the vehicle (12) equipped with the safety device (10) and the frontwardly and rearwardly located vehicles (18), (20). The safety device (10) is particularly useful for warning the driver of approaching vehicles, such as the truck identified by the reference numeral (26), about the presence of pedestrians, cyclers, roller skaters or the like, such as the pedestrian identified by the reference numeral (28), located in the front or the rear spacings (22), (24).

The individual located in the front or rear spacings (22), (24) is typically, at least partially, hidden by the vehicles (12), (18) or (20) and is thus typically only seen at the very last instant by the driver of approaching vehicles such as the vehicle (26).

The view of the individual (28) is also at least partially blocked by the vehicles (12), (18) or (20) and, hence, the individual (28) may only see approaching vehicles, such as the vehicle (26), at the very last instant. Consequently, if the individual (28) decides to step out of the spacing (22) into the roadway (16) the risk of collision between the approaching vehicle (26) and the individual (28) is relatively high since the view of both the driver of the vehicle (26) and the individual (28) is at least partially obstructed by the vehicles (12), (18) and/or (20).

Since approaching vehicles such as the vehicle (26) have a given inertia depending on their relative speed and mass, even if the driver of the vehicle (26) eventually sees the individual (28) before the latter reaches the roadway (16), the required braking distance may not be sufficient to avoid a collision. This type of situation is unfortunately too often exemplified by children running in the spacings (22), (24) during play, to retrieve a ball or in other situations wherein their lack of experience and magical thoughts lead them to stepping carelessly into the roadway (16) often without even thinking about the presence potentially approaching vehicles, such as the vehicle (26).

The vehicle safety system (10) includes at least one and preferably two motion sensors schematically illustrated schematically and designated by the reference numeral (30). The motion detectors (30) are typically located adjacent the front and rear ends of the vehicle (12) and are adapted to sense the presence of individuals, such as the individual (28), located within a predetermined range of the vehicle (12) and, hence, typically located within the front and rear spacings (22), (24).

Preferably the motion detectors are selected, positioned and sized so as to allow sensing of individuals only within a predetermined linear and angular range. Preferably, the sensors (30) only become activated when sensing movement within a range of approximately 3 ft. directly in front and in the back of the vehicle (12). The linear range is typically set to the typical distance between parallel parked cars, such as the vehicles (12), (18) and (20), while the angular range is set so that the sensors are not activated when movement is sensed along side the vehicle (12). This prevents the sensors (30) from being activated by pedestrians, vehicles or the like passing laterally alongside the vehicle (12).

Typically, although by no means exclusively, the sensor is a microwave-type motion sensor preferably allowing for a single zone of detection and designed for automotive security systems. One example of such motion sensors is the model AS-112 manufactured by the Audiovox Inc. Co. The radius of the sensing zone can be adjusted by turning a screw on the sensor. The radius can be adjusted from a radius much smaller than the 3 ft. required for the proposed system to a much larger radius.

Furthermore, the sensing zone completely surrounds the detector and the microwaves employed for detection do not pass through metal. This characteristic combined with a judicious positioning of the detector allows for the setting of the angular range.

As such, the sensor must be placed close to the longitudinal ends of the vehicle and positioned so that the metal will block undesired portions of the detection zone while the desired detection zone is free from metal blocking. For example, the front motion detector may be mounted behind a grill made out of polymeric resin adjacent the front end of the vehicle. The metal of the front hood and side panels along with adequate adjustment of the detection zone radius will ensure that only motion beyond the front of the car will be detected. A similar type of setting may be provided in the trunk of the vehicle.

The motion detector is typically provided with features allowing the latter to withstand harsh environment, such as rain, snow, wind and the like and is typically protectively enclosed within a suitable polymeric container secured to the vehicle.

The vehicle safety device (10) also includes a signal emitting means adapted to emit a signal that will be visible, audible or both to approaching vehicles even in low visibility conditions such as during fog, snow or in bright daylight. For example, a combination of strobe lights and lasers has been found to produce a relatively efficient visual signal.

White strobe lights provide maximal visibility in daylight especially when combined with short attention getting bursts of intense light. At night, typically, a 4 ft. line of red laser light projected on the roadway (16) perpendicular to the side of the vehicle (12) will be visible.

In FIG. 1, the stroboscopes are schematically illustrated and designed by the reference number (32) while the lasers and associated laser beams are schematically illustrated and designated respectively by the reference numerals (34), (36). When a laser (34) is used, the laser (34) is preferably provided with both eye safety and visibility features. The selection of the laser is guided by a compromise between visibility which generally increases with laser power and the safety which generally diminishes with laser power as the risk of retinal damage from looking directly into the beam increases with the laser power.

Typically, although by no means exclusively, the laser (34) is of the non-Gaussian type typically provides a red laser line. Laser beams from non-Gaussian generators have a relatively uniform intensity along their length while laser beams from Gaussian generators have a hot spot “of high intensity” in the center and “low intensity” near the longitudinal ends of the lines. Thus, the Gaussian generators do not provide as crisp a line and are potentially more dangerous due to the hot spot than non-Gaussian generators of the same power.

In addition, the color red was preferably chosen as it is most associated with stop signals such as intersection traffic lights, automobile brake lights, stop signs and the like. The use of the red color thus decreases the reaction or response time of the vehicle driver to the signal generated by the indicator 10.

Although a green laser light may be more visible than a red one of the same power, as the eye is more sensitive to the green light, green lasers often cost significantly more than red lasers and the color green is associated typically with “go” signals.

Furthermore, the choice of a laser emitted line instead of a laser emitted dot pattern is based on the fact that focusing the laser light into a pattern of dots rather than distributing it along the line was found to provide no appreciable increase in visibility despite the significantly increased cost.

Typically, although by no means exclusively, the lasers conform to class 2M specifications. This ensures that the lasers are pro-for not for the application in the pro-pro system yet not so powerful that the system will not be approved by North American governments. However, warning label, appropriate laser class 2M will be preferably be affixed to a clearly visible location on vehicles equipped with the system.

Class 2M while not currently employed as laser power specification, is one of a new set of classifications that will presumably be adapted into international laser standards in the near future. It is defined by the collection of the maximum power of 1 mW through a 7 mm. aperture located 10 cm. from the source.

Typically, although by no means exclusively, the laser line generator is of a type such as model SNF-701L-635-10-30 manufactured by The Lasiris Inc. Co. while the strobe light is of a type such as model ANSLWH manufactured by The Streetglow Inc. Co., and the head light is of a type such as the strobe model ANHLS also manufactured by The Streetglow Inc. Co. The laser is a solid state-type of red wavelength and a 10 mW power. It has a fan angle of 30° and is typically used with a voltage converter for operation at 12 VDC.

Typically, one laser and one strobe light or head-light strobe are mounted adjacent each corner of the vehicle (12) on the side of the vehicle at approximately head-light level. Thus, four lasers and four strobes are typically required. Typically, metal brackets are used to mount strobe lights and lasers near the outside edge of the vehicles wheel wells.

Also, typically, the lasers are mounted at an angle such that the red light projected on the roadway (16) alongside the vehicle (12) is perpendicular to the vehicle (12) and approximately 4 ft. in length. As the lasers are tunable, the aforementioned lines (36) could be made relatively constant in intensity along their length rather than brighter at the end nearest the vehicle (12).

Alternatively, automobile manufacturers could place the signaling devices behind the head-lights and tail light lenses, in the side rear view mirror housing or other suitable locations.

The signaling devices (32), (34) are typically preferably protectively enclosed against environmental elements, such as rain, snow, wind or the like within suitable containers.

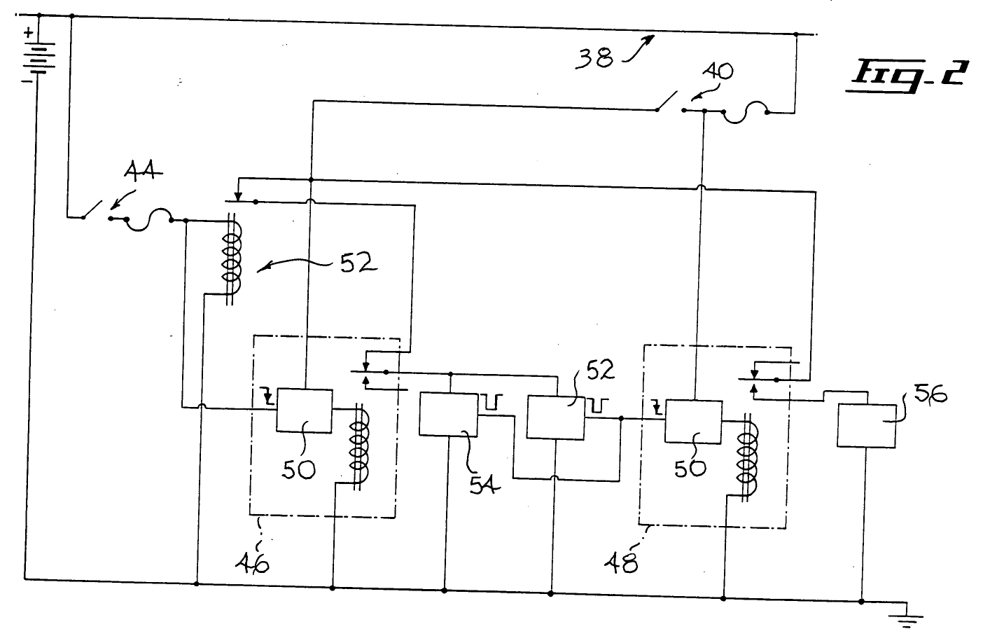

The vehicle safety device (10) further includes a means for selectively activating both the motion sensors (30) and the signaling means depending on predetermined conditions. Typically, an electronic circuitry such as circuitry (38) exemplified schematically in FIG. 2 is used.

The circuitry (38) typically includes a master power switch (40) that must be on the “on” state for the system to function. Any type of conventional automotive switch can be used as the main power switch (40). The main power switch (40) is typically mounted on the dashboard of the vehicle (12). The master power switch (40) allows electrical coupling of the circuitry with the conventional battery (42) of the vehicle (12) which provides electrical current for activating the device (10).

The circuitry (38) is also electrically coupled to the ignition switch (44) of the vehicle (12) so that the system (10) may be automatically switched “on” when the ignition switch (44) of the vehicle (12) is switched “off” and vise-versa. The circuitry (38) also includes a first timer relay (46) and a second timer relay (48). Each timer relay (46), (48) typically includes a variable timer component (50) typically jestable through a range of 0 to 90 seconds.

The first timer relay (46) is preferably used to set the delay of system activation following ignition turn “off” when the master power switch (40) is “on” or the master power switch turn “on” when the ignition switch (44) is “off”. Typically, although by no means exclusively, the delay of system activation is set to a value substantially in the range 30 seconds.

The second time relay (48) is used to set the duration of activation of the signaling devices (32), (34) after sensing of individuals such as individual (28) by the sensors (30). Typically, although by no means exclusively, the second timer relay is set to a value substantially in the range 10 seconds.

One example of a conventional timer component (50) that can be used as the timer relays (46), (48) is the model LNK528T manufactured by The Links Electronics Inc. Co. The circuitry (38) further includes a 12 VDC relay (52) as well as connections (54) to the front motion sensor (30), connections (56) to the rear motion detector (30′) and connections (56) to the signaling devices (32), (34).

When the master switch (40) is in the “on” state, the following operational sequence exemplifies a possible connection between the sensors (30) and the signaling means (32), (34). When the ignition switch (44) is turned “off” the coil of the 12 VDC relay (52) is de-energized thus activating the normally closed loop that connects the first timer relay (41) to the battery (42).

In addition, the negative going voltage edge created by turning the ignition (44) “off” initiates counting by the first timer relay (46). When the counting by the first timer relay (46) is finished the motion detector connected to the normally closed loop of the first timer relay (46) is activated by receiving battery voltage through the 12 VDC relay (52) and the first timer relay (46).

Every time either one of the motion detectors (30), (30′) detects an individual (28) it sends a negative voltage pulse to the second timer relay (48). The latter is triggered by the negative going voltage edge and begins counting. While the second timer relay (48) counts, battery voltage is supplied to the signaling devices (32), (34) through its normally opened loop.

The circuitry (38) is deactivated when the ignition switch (44) is turned “on”, breaking the normally closed loop of the 12 VDC relay (52). Thus, the 12 VDC relay (52) ensures the system will only be active when the vehicle (12) is off. In use, with the hereinabove mentioned settings, approximately 30 seconds after the ignition of the vehicle (12) is turned “off”, with the master power switch (40) “on”, the system is activated. Every time an individual (28) is detected within 3 ft. directly in front or in back of the vehicle (12) the strobe lights (32) and the lasers (34) are illuminated for a period of approximately 10 seconds. The system is deactivated by turning the ignition switch (44) “on” or the master power switch (40) “off”. If the ignition switch (44) is “off” and the master power switch (40) is “off”, turning the master power switch (40) “on” will result in a 30 second delay before activation of the system.

At present, the device (10) detects any individuals within the sensing ranges including potentially the driver returning to his vehicle if he does so through the zone of detection. This is due to the method of automatic activation employed. If this is not desired, a remote “on/off” switch could be used. If it is decided that optionally a remote “on/off” switch is desired in place of the automatic switching, the remote switch would take the place of the master power switch (40) in the schematic diagram illustrated in FIG. 2.

The first timer relay (46) would no longer be required (no delay before system activation). The motion detector (30) would connect directly to the 12 VDC relay (52) where the first timer relay (46) is not connected. The remote “on/off” switch would also solve the problem of detection of driver by the system when the driver returns to the car is he does so in the zone of detection.

However, some form of automatic switching is probably preferable as a remote switch requires the driver to remember to turn the system “on”. Also, optionally, a strobing module could be added to the lasers to make the projected lines flash on the street or roadway (16). This could possibly increase the visibility of the laser lines.

1. A pedestrian presence indicator mountable to a vehicle for warning nearby traffic about the presence of a pedestrian within a predetermined target zone; said vehicle defining a vehicle front end, a vehicle rear end, a pair of vehicle side ends and a vehicle longitudinal axis, said vehicle also including a vehicle electric circuitry powered by a vehicle battery, said vehicle circuitry including an ignition switch; said sign signaling device comprising:
a sensing means mounted to said vehicle for sensing the presence of said pedestrian upon said pedestrian being positioned within said target zone;
a signaling means coupled to said sensing means for emitting a warning signal perceivable by said nearby traffic upon said sensing means sensing the presence of said pedestrian within said target zone.

2. A pedestrian presence indicator as recited in claim 1 wherein said signaling means emits said warning signal when said pedestrian is positioned in front or in back of said vehicle within a predetermined distance from said vehicle.

3. A pedestrian presence indicator as recited in claim 2 wherein said predetermined distance is approximately three feet.

4. A pedestrian presence indicator as recited in claim 2 wherein said signaling means is not activated by the presence of said pedestrian along side said vehicle.

5. A pedestrian presence indicator as recited in claim 1 wherein said sensing means includes a motion detector.

6. A pedestrian presence indicator as recited in claim 5 wherein said motion detector is a microwave sensor.

7. A pedestrian presence indicator as recited in claim 6 wherein said microwave sensor is configured, sized and positioned so that said microwave sensor does not sense the presence of said pedestrian when said pedestrian is located along side said vehicle.

8. A pedestrian presence indicator as recited in claim 7 wherein said sensing means includes a front microwave sensor and a rear microwave sensor, said front and rear microwave sensors being respectively positioned underneath the hood and inside the trunk of said vehicle; said front and rear microwave sensors being configured, sized and positioned so as to use the metallic components of said vehicle as microwave shields for ensuring that said microwave sensors do not sense the presence of said pedestrian when said pedestrian is located along side said vehicle.

9. A pedestrian presence indicator as recited in claim 5 wherein said microwave sensor is protectively enclosed within a polymeric sensor shield, said sensor shield being secured to said vehicle.

10. A pedestrian presence indicator as recited in claim 1 wherein said signaling means allows for the emission of a visual warning signal

11. A pedestrian presence indicator as recited in claim 10 wherein said signaling means allows for the emission of a visual warning signal positioned so as to be visible by nearby traffic when said vehicle is parked in parallel alongside a road.

12. A pedestrian presence indicator as recited in claim 11 wherein said signaling means includes a laser mounted to said vehicle.

13. A pedestrian presence indicator as recited in claim 12 wherein said laser is a non-Gaussian laser.

14. A pedestrian presence indicator as recited in claim 12 wherein said laser allows for the emission of a red colored laser beam.

15. A pedestrian presence indicator as recited in claim 12 wherein said laser is mounted to said vehicle so as to emit a laser beam substantially perpendicular to said vehicle longitudinal axis.

16. A pedestrian presence indicator as recited in claim 12 wherein said laser is a non-Gaussian laser allowing for the emission of a red colored laser beam over a distance of approximately four feet and directed substantially perpendicularly relative to said vehicle longitudinal axis.

17. A pedestrian presence indicator as recited in claim 11 wherein said signaling means includes four lasers respectively mounted to said vehicle adjacent a corresponding corner section thereof.

18. A pedestrian presence indicator as recited in claim 17 wherein each of said lasers is a non-Gaussian laser allowing for the emission of a red colored laser beam over a distance of approximately four feet and directed substantially perpendicularly relative to said vehicle longitudinal axis.

19. A pedestrian presence indicator as recited in claim 11 wherein said signaling means includes a strobe light mounted to said vehicle.

20. A pedestrian presence indicator as recited in claim 11 wherein said signaling means includes four strobe lights respectively mounted to said vehicle adjacent a corresponding corner section thereof.

21. A pedestrian presence indicator as recited in claim 1 further comprising activating means for selectively activating said sensing means and said signaling means upon said ignition switch being set in an off position.

22. A pedestrian presence indicator as recited in claim 21 further comprising a delay means for delaying the activation of said sensing and signaling means for a predetermined delay period upon said ignition switch being set in an off position.

23. A pedestrian presence indicator as recited in claim 1 further comprising a signal maintaining means for maintaining the emission of said warning signal for a predetermined duration period upon said signaling means being activated.

24. A pedestrian presence indicator as recited in claim 1 further comprising a remote control for allowing selective remote activation and deactivation of said sensing and signaling means.

25. In combination, a vehicle and a pedestrian presence indicator mounted on said vehicle for warning nearby traffic about the presence of a pedestrian within a predetermined target zone; said vehicle defining a vehicle front end, a vehicle rear end, a pair of vehicle side ends and a vehicle longitudinal axis, said vehicle also including a vehicle electric circuitry powered by a vehicle battery, said vehicle circuitry including an ignition switch; said sign signaling device comprising:
a sensing means mounted to said vehicle for sensing the presence of said pedestrian upon said pedestrian being positioned within said target zone;
a signaling means coupled to said sensing means for emitting a warning signal perceivable by said nearby traffic upon said sensing means sensing the presence of said pedestrian within said target zone.

26. A combination as recited in claim 25 wherein said signaling means emits said warning signal when said pedestrian is positioned in front or in back of said vehicle within a predetermined distance from said vehicle.

27. A combination as recited in claim 25 wherein said sensing means includes a front microwave sensor and a rear microwave sensor, said front and rear microwave sensors being respectively positioned underneath the hood and inside the trunk of said vehicle; said front and rear microwave sensors being configured, sized and positioned so as to use the metallic components of said vehicle as microwave shields for ensuring that said microwave sensors do not sense the presence of said pedestrian when said pedestrian is located along side said vehicle.

28. A combination as recited in claim 25 wherein said signaling means allows for the emission of a visual warning signal positioned so as to be visible by nearby traffic when said vehicle is parked in parallel alongside a road.

29. A combination as recited in claim 28 wherein said signaling means includes a laser mounted to said vehicle.

30. A combination as recited in claim 29 wherein said laser is mounted to said vehicle so as to emit a laser beam substantially perpendicular to said vehicle longitudinal axis.

31. A combination as recited in claim 29 wherein said laser is a non-Gaussian laser allowing for the emission of a red colored laser beam over a distance of approximately four feet and directed substantially perpendicularly relative to said vehicle longitudinal axis.
